(19) United States
(12) Patent Application Publication
(10) Pub. No.: US 2015/0097658 A1
(43) Pub. Date: Apr. 9, 2015

(54) DATA PROCESSING APPARATUS AND DATA PROCESSING PROGRAM

(71) Applicant: Nikon Corporation, Tokyo (JP)

(72) Inventors: Takeshi Yagi, Tokyo (JP); Mikiya Tanaka, Chigasaki (JP); Kei Kitani, Atsugi (JP); Satoshi Akasaka, Yokohama (JP); Takatsugu Aoyama, Fujisawa (JP); Kazuhito Syoji, Naka-gun (JP); Satori Ishiyama, Tokyo (JP)

(73) Assignee: Nikon Corporation, Tokyo (JP)

(21) Appl. No.: 14/503,843

(22) Filed: Oct. 1, 2014

Related U.S. Application Data
(63) Continuation of application No. PCT/JP2013/060455, filed on Apr. 5, 2013.

(30) Foreign Application Priority Data
Apr. 6, 2012 (JP) 2012-087310

(51) Int. Cl. G08B 6/00

(52) U.S. Cl. CPC G08B 6/00
USPC 340/407.1

(57) ABSTRACT

A data processing apparatus includes: a receiving unit configured to receive data including information indicating amplitude and information indicating frequency; and a processing unit configured to produce data used to generate vibration of a vibration unit based on the data and predetermined vector information.

### CROSS-REFERENCE TO RELATED APPLICATION

This is a Continuation application of International Application No. PCT/JP2013/60455 filed on Apr. 5, 2013, which claims priority on Japanese Patent Application No. 2012-87310 filed on Apr. 6, 2012. The contents of the aforementioned applications are incorporated herein by reference.

### BACKGROUND

1. Field of the Invention

The present invention relates to a data processing apparatus and a data processing program.

2. Background

An apparatus disclosed in Japanese Unexamined Patent Application Publication No. 2010-86089 may be provided with a vibration unit for generating vibration in some cases. As such a vibration unit, for example, an eccentric motor is known.

### SUMMARY

However, such an apparatus, for example, just vibrates corresponding to the display of images. Accordingly, there is a problem that the user is not able to obtain a dramatic impact by use of vibration.

An object of an aspect of the present invention is to provide a data processing apparatus and a data processing program capable of processing vibration data for obtaining a dramatic impact by use of vibration.

An aspect of the present invention is a data processing apparatus including: a receiving unit configured to receive data including information indicating amplitude and information indicating frequency; and a processing unit configured to produce data used to generate vibration of a vibration unit based on the data and predetermined vector information.

Another aspect of the present invention is a data processing program used to cause a computer to perform: receiving data including information indicating amplitude and information indicating frequency; and producing data used to generate vibration of a vibration unit based on the data and predetermined vector information.

According to an aspect of the present invention, a data processing apparatus can process vibration data for obtaining a dramatic impact by use of vibration.

### BRIEF DESCRIPTION OF THE DRAWINGS

FIG. 1 is a block diagram showing a configuration example of an authoring system and an application apparatus according to an embodiment of the present invention.

FIG. 2 is an external view showing a configuration example of an application apparatus according to an embodiment of the present invention.

FIG. 3 is a diagram showing an example of an apparent movement by which the user can obtain a movement sensation according to an embodiment of the present invention.

FIG. 4 is a table showing an example of a format of a VIB file according to an embodiment of the present invention.

FIG. 5 is a table showing an example of a format of a VIB file according to an embodiment of the present invention.

FIG. 6 is a table showing an example of a format of a VIB file according to an embodiment of the present invention.

FIG. 7 is a drawing showing an example of a division process when performing a syntax analysis of VIB data according to an embodiment of the present invention.

FIG. 8 is a drawing showing an example of a division process when producing VIB data according to an embodiment of the present invention.

FIG. 9 is a sequence diagram showing an example of an operation step when performing a syntax analysis of VIB data according to an embodiment of the present invention.

FIG. 10 is a sequence diagram showing an example of an operation step when producing VPCM data based on PCM data according to an embodiment of the present invention.

FIG. 11 is a sequence diagram showing an example of an operation step when producing VPCM data based on predetermined waveform data according to an embodiment of the present invention.

FIG. 12 is a sequence diagram showing an example of an operation step when producing VIB data based on VPCM data according to an embodiment of the present invention.

### DESCRIPTION OF THE EMBODIMENTS

An embodiment of the present invention will be described in detail with reference to the drawings. Hereinafter, a dramatic impact which the user of an application apparatus can obtain by causing the user a localization sensation, a movement sensation, and the like is referred to as “vibration effect”. The localization sensation is a phantom sensation, that is, a sensation which the user senses as if, when two points of the skin of the user are simultaneously vibrated (stimulated), there is the localization of the vibration at a specific position between the two points. The movement sensation is an apparent movement, that is, a sensation which the user senses as if, when two points of the skin of the user are vibrated (stimulated) with a phase difference and a power difference, the localization of the vibration moves.

Hereinafter, PCM (Pulse Code Modulation) data as uncompressed waveform data, which is processed to be capable of providing vibration effect, is referred to as “VPCM data”. AAC (Advanced Audio Coding) data as compressed waveform data, which is processed to be capable of providing vibration effect, is referred to as “VAAC data”. The waveform data may include tone burst so as to be capable of providing further vibration effect.

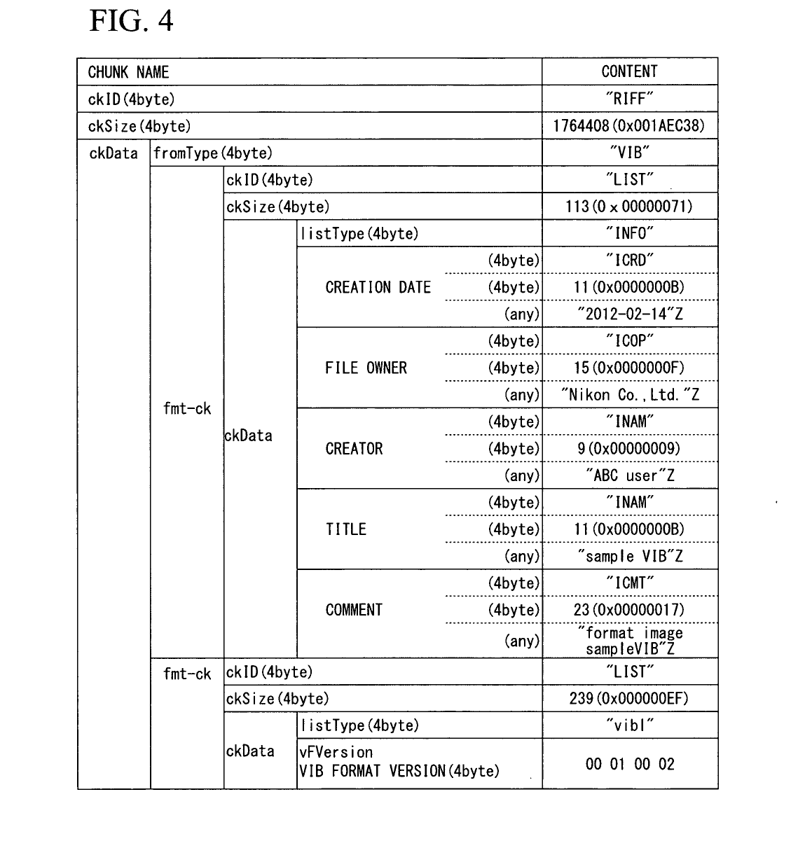

Hereinafter, data including waveform data (VPCM data, or VAAC data), which is processed to be capable of providing a vibration effect, in accordance with a predetermined format is referred to as “VIB data (vibration data)”. Hereinafter, a file including VIE data is referred to as “VIE file (vibration file)”. A format will be described later with reference to FIG. 4 to FIG. 6.

First, configuration examples of an authoring system (vibration data producing and editing system) and an application apparatus are described.

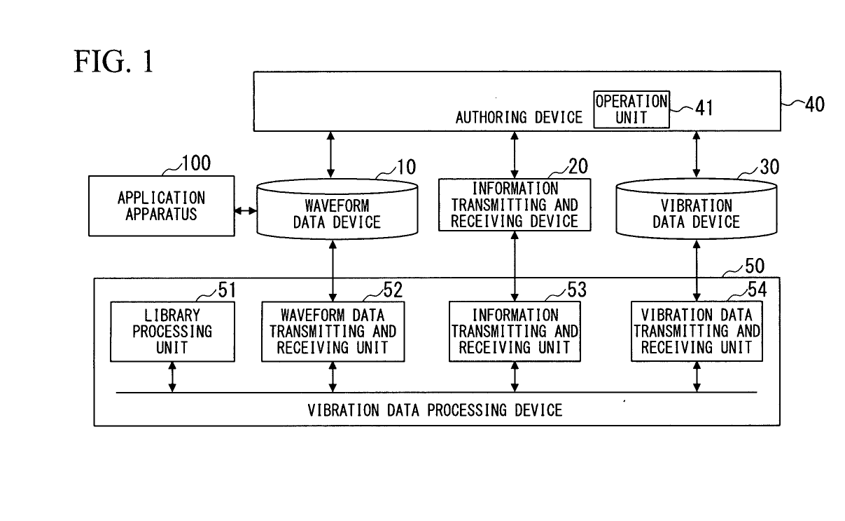

In FIG. 1, a configuration example of an authoring system and an application apparatus is shown by a block diagram. The authoring system includes an authoring device 40, a waveform data device 10, an information transmitting and receiving device 20, a vibration data device 30, and a vibration data processing device 50 (data processing apparatus). An application apparatus 100 acquires VPCM data or VAAC data from the waveform data device 10.

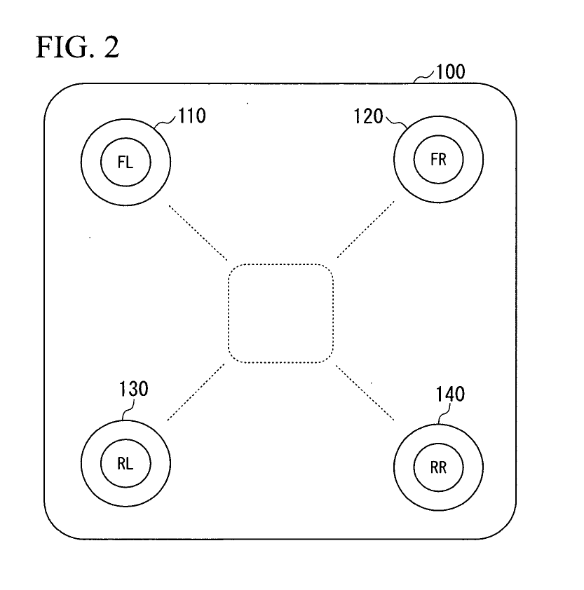

In FIG. 2, a configuration example of an application apparatus is shown by an external view. The application apparatus 100 includes, as an example, vibration units (vibrator, vibration device) 110, 120, 130, and 140 on the corners of the body of the application apparatus 100. The application apparatus 100 vibrates the body of the application apparatus 100 by vibrating each vibration unit based on VPCM data or VAAC data.

In other words, the application apparatus 100 vibrates the body of the application apparatus 100 based on VPCM data or VAAC data, which are data for generating vibration of the vibration units 110, 120, 130, and 140.

In addition, the application apparatus 100 may vibrate each vibration unit based on a VIB file while reproducing image (video) data and audio data.

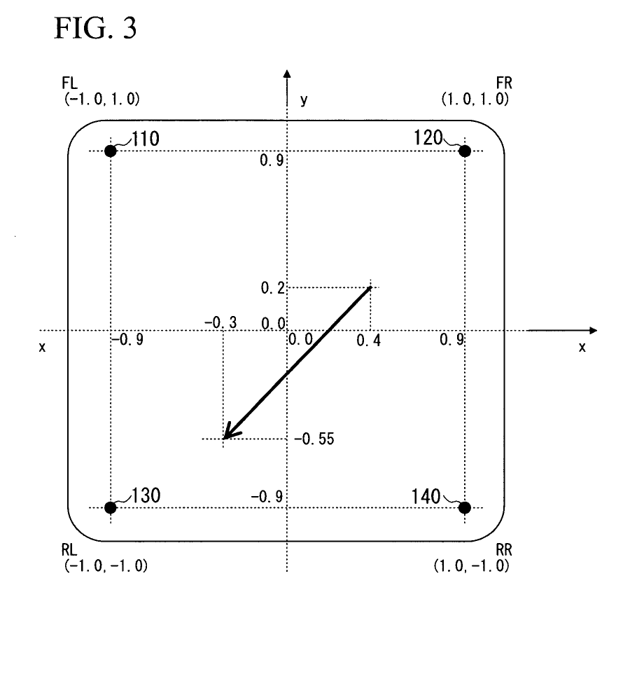

In FIG. 3, an example of an apparent movement by which the user can obtain a movement sensation is shown. For illustrative purposes, a coordinate system (x, y)=(−1.0 to +1.0, −1.0 to +1.0) is defined in which the center of the body of the application apparatus 100 is an origin.

The vibration unit 110 (channel 1) is arranged, for example, at a coordinate (−0.9, +0.9). The vibration unit 120 (channel 2) is arranged, for example, at a coordinate (+0.9, +0.9). The vibration unit 130 (channel 3) is arranged, for example, at a coordinate (−0.9, −0.9). The vibration unit 140 (channel 4) is arranged, for example, at a coordinate (+0.9, −0.9).

The category of each vibration unit may be a voice coil motor (VCM) or may be a speaker.

In FIG. 3, as an example, the user can obtain a movement sensation as if the localization of vibration linearly moves from a start point coordinate (+0.4, +0.2) to an end point coordinate (−0.3, −0.55). Hereinafter, information including a start point coordinate and an end point coordinate is referred to as “vector information”. The start point coordinate and the end point coordinate may be represented by a relative coordinate. In addition, the vector information may further include information indicating a vibration time (ring time) for which the vibration unit continues vibration.

With reference to FIG. 1 again, the configuration example of the authoring system is further described. The authoring device 40 includes an operation unit 41. The operation unit 41 accepts an operation input. The authoring device 40 functions as an authoring tool which produces and edits VIB data based on the operation input accepted by the operation unit 41.

For example, the authoring device 40 causes the waveform data device 10 to preliminarily store waveform data (for example, PCM data, AAC data), which is preliminarily produced based on voice data. The waveform data includes, for example, information indicating intensity (amplitude) of vibration and information indicating frequency of vibration waveform.

In addition, for example, the authoring device 40 transmits and receives a variety of information (described later) to and from the vibration data processing device 50 via the information transmitting and receiving device 20. In addition, for example, the authoring device 40 may transmit and receive a VIB file to and from the vibration data processing device 50 via the vibration data device 30.

The waveform data device 10 preliminarily stores PCM data and AAC data, which are preliminarily produced by the authoring device 40 based on voice data. In addition, the waveform data device 10 stores VPCM data and VAAC data, to which a process (production, or syntax analysis) is applied by the vibration data processing device 50.

The vibration data device 30 stores a VIB file. The VIB file may be a file produced by the vibration data processing device 50, or may be a file stored preliminarily by the authoring device 40. Alternatively, the VIB file may be associated with image (video) data and audio data, and the file may be stored in the vibration data device 30.

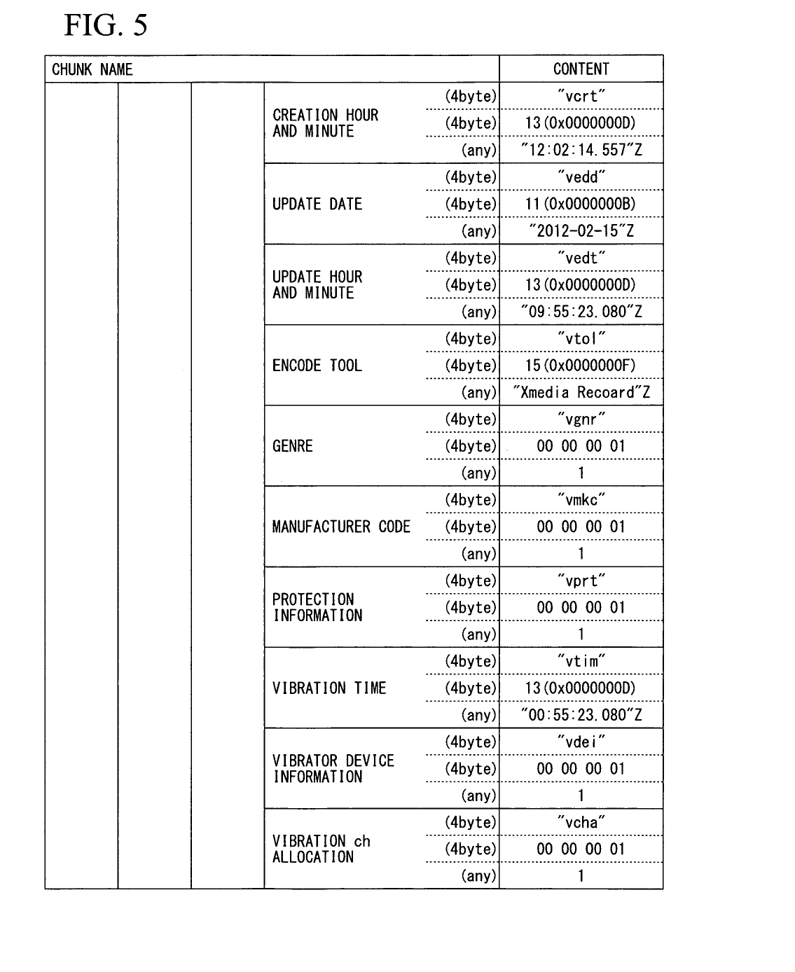

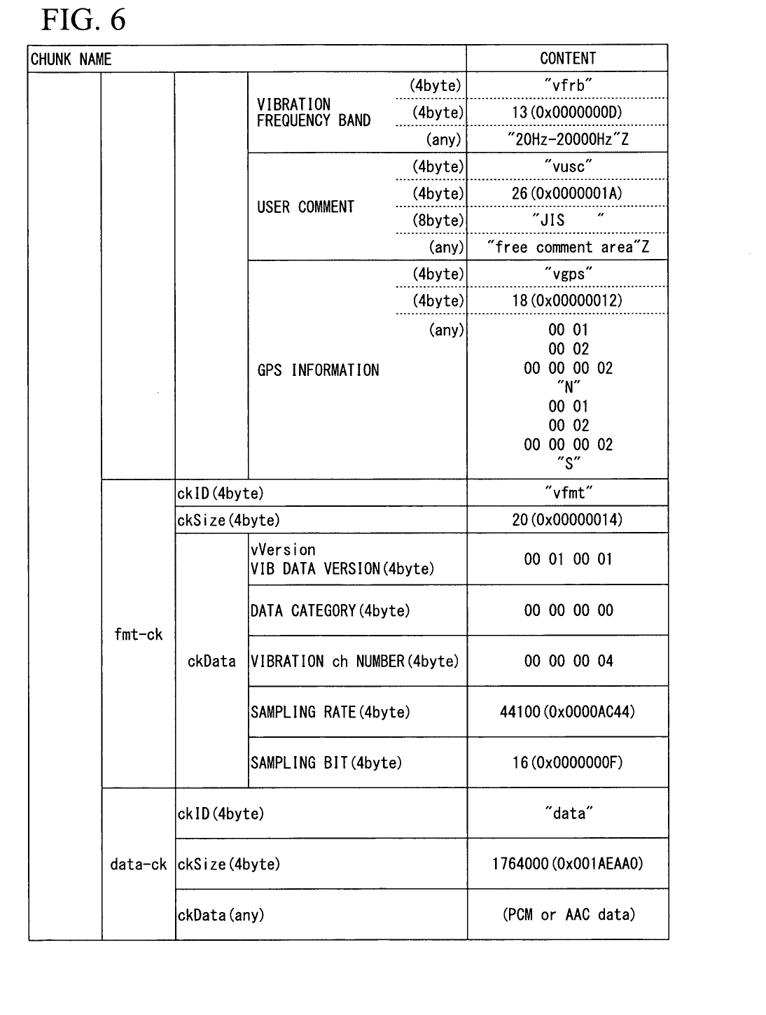

In FIG. 4, FIG. 5, and FIG. 6, an example of a format of the VIB file is shown by use of divided tables. The VIB file includes information indicating a list type “INFO”, information indicating a creation date, information indicating a file owner, information indicating a file creator, information indicating a title (heading), and information indicating a comment.

In addition, the VIB file includes information indicating a list type “vibl”, information indicating a version of a format of the VIB data, information indicating a creation hour and minute (creation time), information indicating an update date, information indicating an update hour and minute (update time), information indicating an encode tool (tool name, or the like), information indicating a genre (for example, image (video), voice, haptic, game), information indicating a manufacturer code of the VIB file, information indicating protection information (presence or absence of protection), information indicating a vibration time (reproduction time), vibrator device information (for example, identification information of the manufacturer of the vibration unit, category information of the vibration unit), information indicating vibration ch (channel) allocation, information indicating a vibration frequency band (single frequency, broadband), information indicating a user comment, and GPS (Global Positioning System) information (geotag).

In addition, the VIB file includes information indicating a version of the VIB file (VIB data), information indicating a category (for example, VPCM having a PCM format, VAAC having an AAC format) of waveform data included in a data region (in FIG. 6, a region represented by “ckData”), information indicating a number of a vibration ch (channel), information indicating a sampling rate (sampling frequency of waveform data), and information indicating a sampling bit (quantized bit number of waveform data).

Hereinafter, information indicating a creation date, information indicating a creation hour and minute (creation time), information indicating an update date, information indicating an update hour and minute (update time), information indicating a version of a format of the VIB data, information indicating a version of the VIB file (VIB data), information indicating a category of waveform data included in a data region, information indicating a number of a vibration ch, information indicating a sampling rate, information indicating a sampling bit, information indicating a file owner, information indicating a file creator, information indicating a title, information indicating a comment, information indicating an encode tool, information indicating a genre, information indicating a manufacturer code of the VIB file, information indicating protection information, information indicating a vibration time, vibrator device information, information indicating vibration ch allocation, information indicating a vibration frequency band, information indicating a user comment, and GPS information (geotag) are referred to collectively as “VIB information”.

In addition, hereinafter, information indicating a layout (coordinate) of the vibration unit in the application apparatus 100 (refer to FIG. 2 and FIG. 3), information indicating a number of a vibration ch (channel), information indicating a sampling rate (sampling frequency of PCM data), and information indicating a sampling bit (quantized bit number of PCM data) are referred to collectively as “configuration information”. Each of a number of a vibration ch (channel), a sampling rate, and a sampling bit is determined based on VIB information.

With reference to FIG. 1 again, the configuration example of the authoring system is further described. The information transmitting and receiving device 20 relays a variety of information transmitted and received between the authoring device 40 and the vibration data processing device 50.

For example, the information transmitting and receiving device 20 receives vector information from the authoring device 40 and forwards the received vector information to the vibration data processing device 50. For example, the information transmitting and receiving device 20 receives fixed waveform information from the authoring device 40 and forwards the received fixed waveform information to the vibration data processing device 50. The fixed waveform information includes, for example, information indicating intensity (amplitude) of vibration, information indicating frequency of predetermined vibration waveform (for example, rectangular wave), information indicating a coefficient of tone burst, and information indicating a vibration mode (uniform, fade-in and fade-out).

In addition, for example, the information transmitting and receiving device 20 receives configuration information from the authoring device 40 and forwards the received configuration information to the vibration data processing device 50.

The vibration data processing device 50 processes VIB data (vibration data) for obtaining a vibration effect. The vibration data processing device 50 includes a library processing unit 51 (processing unit), a waveform data transmitting and receiving unit 52 (receiving unit), an information transmitting and receiving unit 53 (receiving unit), and a vibration data transmitting and receiving unit 54.

The waveform data transmitting and receiving unit 52 transmits and receives waveform data to and from the authoring device 40 via the waveform data device 10. For example, the waveform data transmitting and receiving unit 52 receives waveform data (for example, PCM data, AAC data), which is preliminarily produced based on voice data, from the waveform data device 10 and forwards the received waveform data to the library processing unit 51. In addition, for example, the waveform data transmitting and receiving unit 52 forwards waveform data (for example, VPCM data, VAAC data), to which a process (production or syntax analysis) is applied by the vibration data processing device 50, to the waveform data device 10 and causes the waveform data device 10 to store the forwarded waveform data.

The information transmitting and receiving unit 53 transmits and receives a variety of information to and from the authoring device 40 via the information transmitting and receiving device 20.

For example, the information transmitting and receiving unit 53 receives vector information from the information transmitting and receiving device 20 and forwards the received vector information to the library processing unit 51. For example, the information transmitting and receiving unit 53 receives fixed waveform information from the information transmitting and receiving device 20 and forwards the received fixed waveform information to the library processing unit 51.

In addition, for example, the information transmitting and receiving unit 53 receives configuration information from the information transmitting and receiving device 20 and forwards the received configuration information to the library processing unit 51. For example, the information transmitting and receiving unit 53 receives acceleration data from the information transmitting and receiving device 20 and forwards the received acceleration data to the library processing unit 51.

The vibration data transmitting and receiving unit 54 transmits and receives VIB data (vibration data) to and from the vibration data processing device 50 via the vibration data device 30.

For example, the vibration data transmitting and receiving unit 54 forwards VIB data produced by the vibration data processing device 50 to the vibration data device 30 and causes the vibration data device 30 to store the forwarded VIB data as a VIB file. In addition, for example, the vibration data transmitting and receiving unit 54 receives a VIB file which is preliminarily stored in the vibration data device 30 by the authoring device 40 and forwards the received VIB file to the library processing unit 51.

The library processing unit 51 receives VIB data from the vibration data transmitting and receiving unit 54. The library processing unit 51 performs a syntax analysis of the VIB data and causes the waveform data device 10 to store VPCM data or VAAC data as a syntax analysis result via the waveform data transmitting and receiving unit 52.

In addition, the library processing unit 51 produces VPCM data or VAAC data based on voice data (PCM data, or AAC data) and vector information. Alternatively, the library processing unit 51 may produce VPCM data or VAAC data based on fixed waveform information and vector information.

In addition, the library processing unit 51 produces VIB data including VPCM data or VAAC data in accordance with a format (refer to FIG. 4 to FIG. 6) and causes the vibration data device 30 to store the produced VIB data via the vibration data transmitting and receiving unit 54. In addition, the library processing unit 51 makes VIB data include at least one of information (VIB information) indicating a vibration time of each vibration unit and information (VIB information) indicating a number of the vibration unit and causes the vibration data device 30 to store the VIB data.

In addition, the library processing unit 51 may receive acceleration data from the information transmitting and receiving unit 53 and may produce VIB data based on VPCM data or VAAC data produced corresponding to the received acceleration data. The acceleration data may be acceleration data preliminarily sensed by a sensor, or may be acceleration data input via the operation unit 41 of the authoring device 40.

Note that, when the application apparatus 100 vibrates each vibration unit based on a VIB file while reproducing image data, the library processing unit 51 may produce vector information based on the image. More specifically, the library processing unit 51 may produce vector information corresponding to a trajectory of a mover image which moves in a reproduced image such that the trajectory of the mover image is synchronized with a movement sensation of the localization of vibration by the vibration unit.

That is, the produced vector information is information indicating a trajectory of the movement sensation of the localization of vibration which the user can obtain in the application apparatus 100 provided with the vibration units 110, 120, 130, and 140.

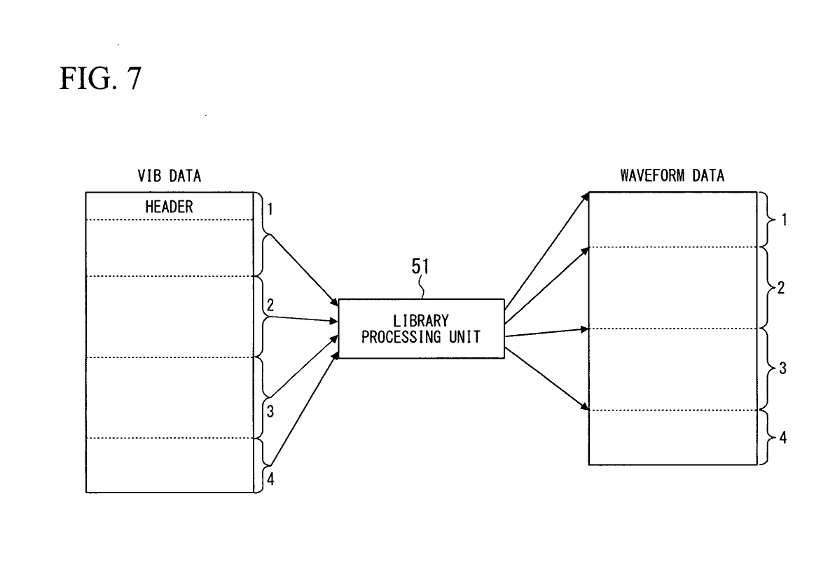

When performing a syntax analysis of VIB data, the library processing unit 51 may perform a division process of the VIB data. In FIG. 7, an example of a division process when performing a syntax analysis of VIB data is shown. In FIG. 7, the library processing unit 51 divides VIB data into four data regions, performs a syntax analysis of the VIB data for each divided data region, and outputs waveform data (for example, VPCM data, VAAC data) as the syntax analysis result. Thereby, the library processing unit 51 can reduce a processing load and a processing time even when the size of VIB data is large.

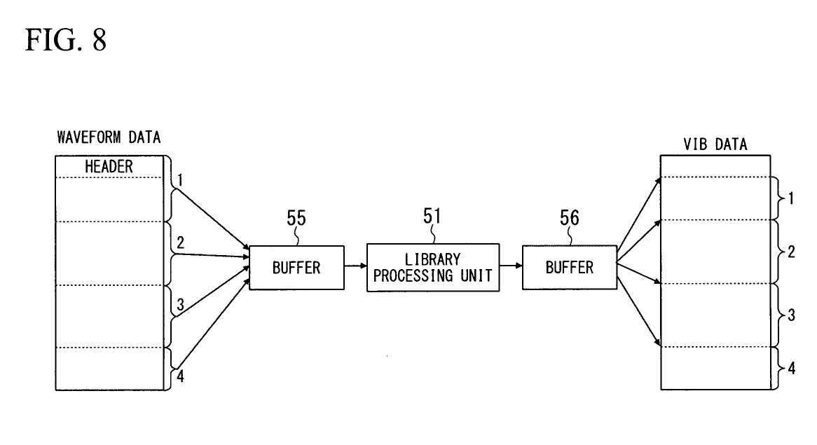

In addition, the library processing unit 51 may perform a division process of waveform data (for example, VPCM data, VAAC data) when producing VIB data. In FIG. 8, an example of a division process when producing VIB data is shown. The vibration data processing device 50 further includes a buffer 55 and a buffer 56. The library processing unit 51 receives waveform data via the buffer 55 and produces VIB data based on the waveform data, for each data region of divided waveform data. The library processing unit 51 transmits the produced VIB data via the buffer 56.

The library processing unit 51 may perform a division process of waveform data when producing VIB data. In FIG. 8, the library processing unit 51 divides waveform data (for example, VPCM data, VAAC data) into four data regions, produces VIB data for each divided data region, and outputs the produced VIB data. Thereby, the library processing unit 51 can produce VIB data by using a small data region managed by the authoring device 40.

Next, an operation step of the authoring system is described.

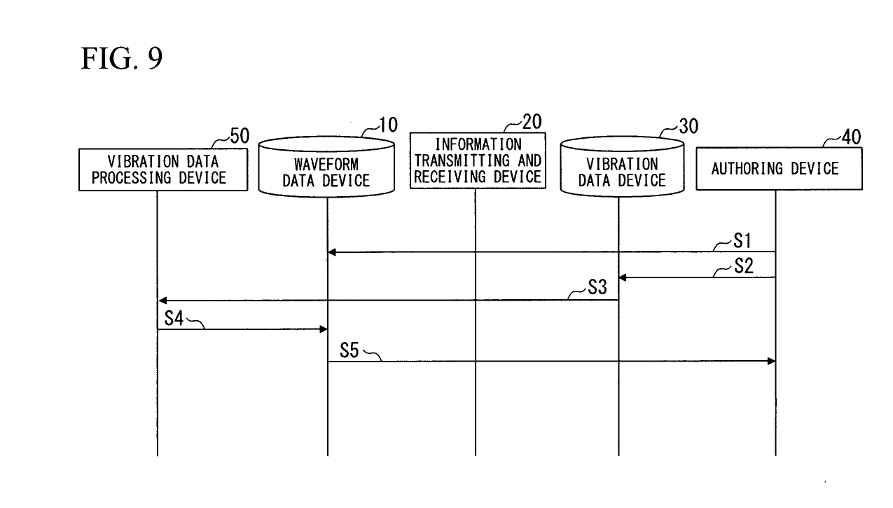

FIG. 9 is a sequence diagram showing an example of an operation step when performing a syntax analysis of VIB data. The authoring device 40 allocates in the waveform data device 10 a region for storing VPCM or VAAC output as a result of a syntax analysis of VIB data (step S1). The authoring device 40 commands the vibration data device 30 to transmit the VIB data to the vibration data processing device 50 (step S2). The vibration data device 30 transmits the VIB data to the vibration data processing device 50 (step S3).

The vibration data processing device 50 performs a syntax analysis of the VIB data in accordance with a format (refer to FIG. 4 to FIG. 6) and transmits VPCM data, VAAC data, or the like as the syntax analysis result to the waveform data device 10 (step S4). The waveform data device 10 stores the received VPCM data, VAAC data, or the like. The waveform data device 10 transmits information indicating that the VPCM data or VAAC data has been stored, to the authoring device 40 (step S5).

Note that, the application apparatus 100 (refer to FIG. 1 and FIG. 2) may reproduce voice from each vibration unit (speaker) based on the VPCM data, VAAC data, or the like stored in the waveform data device 10.

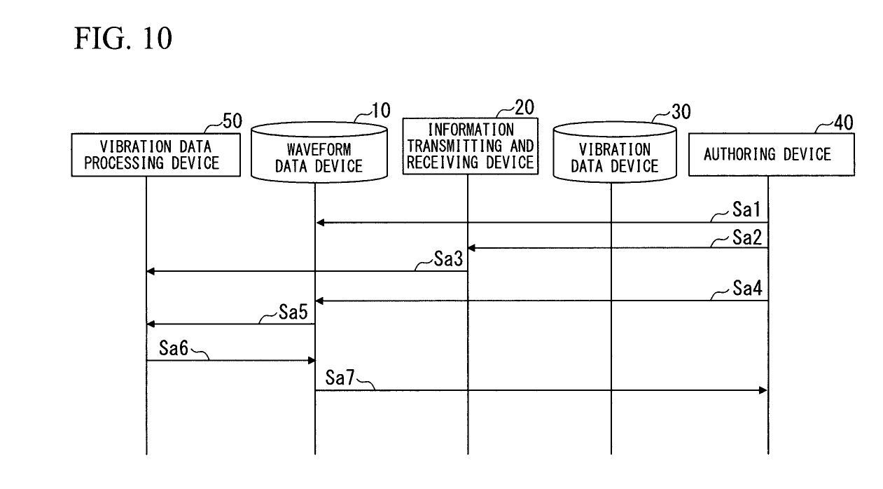

FIG. 10 is a sequence diagram showing an example of an operation step when producing VPCM data based on PCM data. The authoring device 40 allocates in the waveform data device 10 a region for storing VPCM produced based on PCM data (step Sa1).

The authoring device 40 transmits vector information input via the operation unit 41 (refer to FIG. 1) to the information transmitting and receiving device 20 (step Sa2). The information transmitting and receiving device 20 forwards the received vector information to the vibration data processing device 50 (step Sa3). The authoring device 40 commands the waveform data device 10 to transmit the PCM data to the vibration data processing device 50 (step Sa4). The waveform data device 10 transmits the PCM data to the vibration data processing device 50 (step Sa5).

The vibration data processing device 50 produces VPCM data based on the PCM data and vector information so that a vibration effect can be obtained. The vibration data processing device 50 may produce the VPCM data based on a number (count) of the vector information. In addition, the vibration data processing device 50 may make the VPCM data include tone burst so that the vibration effect can be further obtained (step Sa6).

The waveform data device 10 transmits to the authoring device 40 information indicating that the VPCM data has been stored (step Sa7). Note that, the vibration data processing device 50 may produce VAAC data based on AAC data instead of the PCM data.

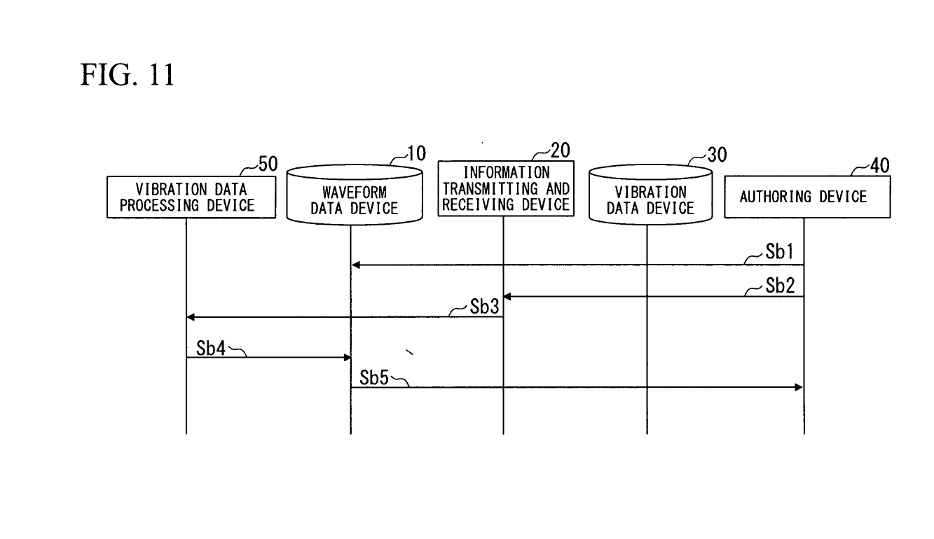

FIG. 11 is a sequence diagram showing an example of an operation step when producing VPCM data based on predetermined waveform data. The authoring device 40 allocates in the waveform data device 10 a region for storing VPCM produced based on fixed waveform information (predetermined waveform data) (step Sb1).

The authoring device 40 transmits fixed waveform information and vector information input via the operation unit 41 (refer to FIG. 1) to the information transmitting and receiving device 20 (step Sb2). The information transmitting and receiving device 20 forwards the received fixed waveform information and vector information to the vibration data processing device 50 (step Sb3).

The vibration data processing device 50 produces VPCM data based on the fixed waveform information and vector information so that a vibration effect can be obtained. The vibration data processing device 50 may produce the VPCM data based on a number (count) of the vector information. In addition, the vibration data processing device 50 may make the VPCM data include tone burst so that the vibration effect can be further obtained (step Sb4).

The waveform data device 10 transmits to the authoring device 40 information indicating that the VPCM data has been stored (step Sb5). Note that, the vibration data processing device 50 may produce VAAC data based on AAC data instead of the PCM data.

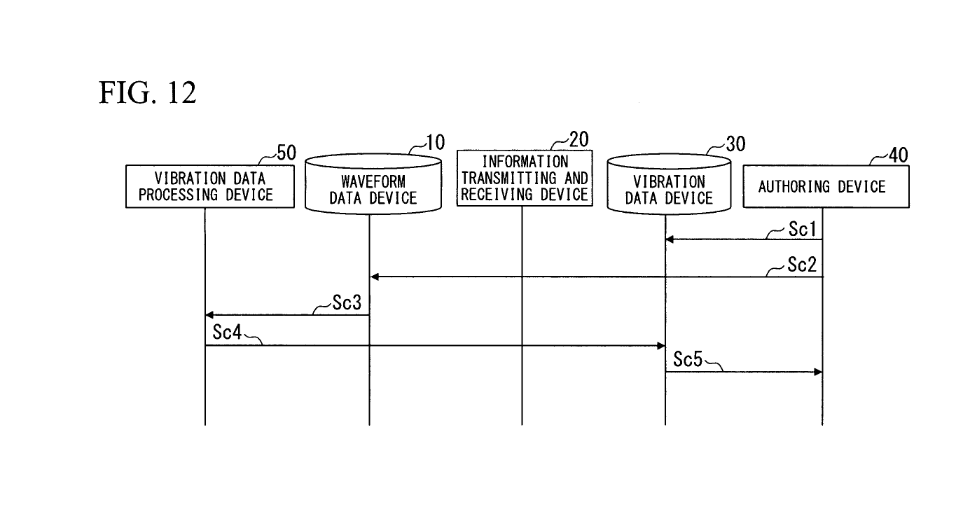

FIG. 12 is a sequence diagram showing an example of an operation step when producing VIB data based on VPCM data. The authoring device 40 allocates in the vibration data device 30 a region for storing VIB data produced based on VPCM data (step Sc1). The authoring device 40 commands the waveform data device 10 to transmit the VPCM data to the vibration data processing device 50 (step Sc2).

The waveform data device 10 transmits the VPCM data to the vibration data processing device 50 (step Sc3). The vibration data processing device 50 produces VIB data including the VPCM data in accordance with a format (refer to FIG. 4 to FIG. 6) and transmits the produced VIB data to the vibration data device 30 (step Sc4). The vibration data device 30 transmits to the authoring device 40 information indicating that the VIB data has been stored (step Sc5).

As described above, the vibration data processing device 50 includes: the waveform data transmitting and receiving unit 52 that receives predetermined data (for example, PCM data or AAC data based on voice data) for determining waveform data (VPCM data, or VAAC data) indicating vibration of the vibration units 110, 120, 130, and 140; information transmitting and receiving unit 53 that receives predetermined data (for example, acceleration data, configuration information, VIB information, vector information, fixed waveform information) for determining the waveform data; and the library processing unit 51 that produces vibration data (VIB data) including the waveform data (VPCM data, or VAAC data) determined by the predetermined data.

According to this configuration, the library processing unit 51 produces vibration data (VIB data) including waveform data (VPCM data, or VAAC data) determined by predetermined data (for example, acceleration data, PCM data or AAC data based on voice data). Thereby, the vibration data processing device 50 can process vibration data (VIB data) for obtaining a dramatic impact (vibration effect) by use of vibration.

In addition, the library processing unit 51 associates at least one of information indicating a vibration time of the vibration units 110, 120, 130, and 140 and information indicating a number (channel number) of the vibration units with the vibration data (VIB data) and causes the vibration data device 30 to store the associated vibration data as a vibration file (VIB file).

Thereby, vibration data (VIB data) can include at least one of information indicating a vibration time of the vibration units 110, 120, 130, and 140 and information indicating a number (channel number) of the vibration units 110, 120, 130, and 140.

In addition, the waveform data transmitting and receiving unit 52 receives voice data as the predetermined data. In addition, the information transmitting and receiving unit 53 receives acceleration data as the predetermined data.

In addition, the library processing unit 51 produces the vibration data (VIB data) such that a position of vibration felt by the user is localized or moved by the plurality of vibration units.

In addition, the library processing unit 51 performs a syntax analysis of the vibration data (VIB data) and outputs the waveform data (VPCM data, or VAAC data) as the syntax analysis result.

In addition, a vibration data processing program (data processing program) is a program for causing a computer to perform: receiving predetermined data (for example, PCM data or AAC data based on voice data) for determining waveform data (VPCM data, or VAAC data) indicating vibration of the vibration units 110, 120, 130, and 140, or receiving predetermined data (for example, acceleration data, configuration information, VIB information, vector information, fixed waveform information) for determining the waveform data; and producing vibration data (VIB data) including the waveform data determined by the predetermined data.

Hereinbefore, the embodiments of the invention are described in detail with reference to the accompanying drawings, but specific configurations are not limited to the embodiments and include a design or the like made in a range without departing from the scope of the invention.

For example, the operation steps (refer to FIG. 9 to FIG. 12) of the authoring system may be combined. In addition, for example, the devices of the authoring system may be an integrated device. In addition, the programs each operating in one of the devices of the authoring system may each operate as a module and thereby may operate as one program as a whole.

Further, a program for realizing the authoring system described above may be recorded on a computer-readable recording medium. In this case, a computer system may read the program recorded on the recording medium and may execute the program, to thereby perform an execution process. Here, the “computer system” may include an OS and hardware such as a peripheral device.

Further, when the WWW system is used, the “computer system” may include a homepage providing environment (or a display environment). Further, the “computer-readable recording medium” refers to a storage device such as a flexible disk, a magneto-optical disk, a ROM, a writable non-volatile memory such as a flash memory, a portable medium such as a CD-ROM, or a hard disk built in the computer system.

Further, the “computer-readable recording medium” includes a recording medium that holds a program for a predetermined time, such as a volatile memory (for example, a dynamic random access memory (DRAM)) inside the computer system that serves as a server or a client when the program is transmitted through a network such as the Internet or a communication channel such as a telephone line.

Further, the program may be transmitted to a different computer system from the computer system that stores the program in the storage device or the like through a transmission medium or by a transmission wave in the transmission medium. Here, the “transmission medium” that transmits the program refers to a medium having a function of transmitting information, such as a network (communication network) such as the Internet or a communication channel (communication line) such as a telephone line.

Further, the program may realize part of the above-described functions.

Further, the program may be a file capable of realizing the functions in cooperation with a program recorded in the computer system in advance, a so-called a differential file (differential program).

In one embodiment, the vibration data processing device 50 includes: the waveform data transmitting and receiving unit 52 that receives predetermined data (PCM data) for determining waveform data (VPCM data) indicating vibration of the vibration units 110, 120, 130, and 140; and the library processing unit 51 that produces vibration data (VIB data) including waveform data (VPCM data) determined by the predetermined data (PCM data).

In the above embodiment, the library processing unit 51 can make the vibration data (VIB data) include at least one of information indicating a vibration time of the vibration units 110, 120, 130, and 140 and information indicating a number of the vibration units 110, 120, 130, and 140 and can cause a storage device to store the vibration data.

In addition, the waveform data transmitting and receiving unit 52 can receive voice data or acceleration data as the predetermined data (PCM data).

In addition, the library processing unit 51 can produce the vibration data (VIB data) such that a position of vibration felt by the user is localized or moved by the vibration units 110, 120, 130, and 140.

In addition, the library processing unit 51 can perform a syntax analysis of the vibration data and can output the waveform data (VPCM data) as the syntax analysis result.

In addition, in one embodiment, a vibration data processing program can cause a computer to perform: receiving predetermined data (PCM data) for determining waveform data (VPCM data) indicating vibration of the vibration units 110, 120, 130, and 140; and producing vibration data (VIB data) including the waveform data (VPCM data) determined by the predetermined data (PCM data).

What is claimed is:

1. A data processing apparatus comprising:
a receiving unit configured to receive data including information indicating amplitude and information indicating frequency; and
a processing unit configured to produce data used to generate vibration of a vibration unit based on the data and predetermined vector information.

2. The data processing apparatus according to claim 1, wherein
the vector information is information indicating a trajectory of a movement sensation of localization of vibration which an user can obtain in an application apparatus provided with the vibration unit.

3. The data processing apparatus according to claim 1, wherein
the receiving unit receives vector information, and
the processing unit produces data used to generate vibration of the vibration unit based on the vector information received by the receiving unit.

4. The data processing apparatus according to claim 1, wherein
the receiving unit receives voice data as the data including information indicating amplitude and information indicating frequency.

5. The data processing apparatus according to claim 1, wherein
the processing unit further produces vibration data, which is data used to generate vibration of the vibration unit and including at least one of information indicating a vibration time of the vibration unit and information indicating a number of the vibration unit.

6. The data processing apparatus according to claim 5, wherein
the processing unit performs a syntax analysis of the vibration data and outputs data used to generate vibration of the vibration unit as a syntax analysis result.

7. A data processing program used to cause a computer to perform:
receiving data including information indicating amplitude and information indicating frequency; and
producing data used to generate vibration of a vibration unit based on the data and predetermined vector information.
